(19) United States
(12) Patent Application Publication
(10) Pub. No.: US 2025/0101868 A1
(43) Pub. Date: Mar. 27, 2025

(54) VISUALIZATION GROUTING DEVICE FOR COAL AND ROCK FISSURES AND TEST METHOD

(71) Applicant: Henan Polytechnic University, Jiaozuo (CN)

(72) Inventors: Dengke Wang, Jiaozuo (CN); Haohang Feng, Jiaozuo (CN); Jianping Wei, Jiaozuo (CN); Lei Wang, Jiaozuo (CN); Hongtu Zhang, Jiaozuo (CN); Chuanqi Zhu, Jiaozuo (CN); Le Wei, Jiaozuo (CN); Banghua Yao, Jiaozuo (CN); Bo Li, Jiaozuo (CN); Leilei Si, Jiaozuo (CN); Zhihui Wen, Jiaozuo (CN); Xiangyu Xu, Jiaozuo (CN); Yong Liu, Jiaozuo (CN); Jian Zhang, Jiaozuo (CN); Baobao Chen, Jiaozuo (CN); Shaobo Li, Jiaozuo (CN); Hewu Liu, Jiaozuo (CN); Shuaibing Song, Jiaozuo (CN); Hao Fan, Jiaozuo (CN); Kun Zhang, Jiaozuo (CN)

(21) Appl. No.: 18/925,352

(22) Filed: Oct. 24, 2024

Related U.S. Application Data
(63) Continuation of application No. PCT/CN2023/106660, filed on Jul. 10, 2023.

(30) Foreign Application Priority Data
Jul. 13, 2022 (CN) 202210823518.X

(51) Int. Cl. E21D 11/10; G01N 15/08

(52) U.S. Cl. CPC E21D 11/10; G01N 15/0826

(57) ABSTRACT

Disclosed are a visualization grouting device for coal and rock fissures and a test method, a test device including a visualization fissure grouting box body, a box body bracket, a grouting device and a monitoring device. A bottom plate is divided into four identical areas, rubber cushion blocks with different specifications are arranged to simulate different fissure widths and tortuosity, artificial protolith thin film is pasted inside, and a grouting hole and a plurality of pressure measuring holes are arranged in the center of the upper top plate. In the present disclosure, the grouting process of fissures under different grouting conditions, such as different fissure widths, roughness, grouting resistance and tortuosity of pore channels can be simulated, the grouting under different fissure conditions can be simultaneously simulated, and the differences of different grouting diffusion forms can be clearly and intuitively analyzed and compared through the visualization box body.

### CROSS-REFERENCE TO RELATED APPLICATIONS

This application is a continuation of PCT/CN2023/106660, filed on Jul. 10, 2023 and claims priority of Chinese Patent Application No. 202210823518.X, filed on Jul. 13, 2022, the entire contents of which are incorporated herein by reference.

### TECHNICAL FIELD

The present disclosure relates to the field of grouting simulation test equipment, and particularly to a visualization grouting device for coal and rock fissures and a test method.

### BACKGROUND

A grouting method is a common technical means to control the deformation of surrounding rock and improve the stability of surrounding rock. Fissure grouting refers to injecting slurry into fissured rock mass through a certain grouting pressure. With the diffusion of slurry, the fissure space is continuously filled, preventing the seepage of groundwater and blocking a water flow channel. Moreover, the solidified slurry can make the broken rock mass form a complete whole, and jointly bear the external stress to resist the deformation of surrounding rock mass, greatly improving the stability and bearing capacity of the surrounding rock mass, thereby improving the mechanical properties of a rock mass structure.

At present, grouting reinforcement engineering has been widely used, but due to the concealment of grouting engineering, the development of grouting theory is far behind the engineering practice, and grouting engineering, especially fissure grouting is still lack of scientific theoretical guidance. A final diffusion distance of slurry in a fissure and the influence of grouting on a rock structure are difficult to find out. The determination of grouting parameters and the design of grouting engineering largely depend on the construction experience, which seriously restrict the development of grouting theory. It is often difficult to determine a reasonable grouting scheme only by engineering experience. If the grouting parameters and grouting scheme are designed too conservatively, although the ideal reinforcement effect is achieved, it is easy to waste resources. If the design of grouting parameters and grouting scheme is too simple, it will save resources, but it will not achieve the ideal grouting effect, leaving serious security risks for roadway construction.

A diffusion radius is the main factor to evaluate grouting effect, and it is very important to grasp a diffusion range of slurry in time. However, the fissured rock mass is deeply buried in the strata, and the fissure network is complex. The flow and diffusion of grouting slurry in the fissures of rock mass is extremely hidden, and it is extremely difficult to observe the diffusion and flow of slurry intuitively. At present, in the actual field engineering, there is a lack of methods for monitoring and identifying the diffusion flow of slurry in fissured rock mass, and as well as a lack of intuitive display methods for the size and influence range of slurry diffusion.

Therefore, it is an urgent technical problem to improve the fissure grouting test device and method in the prior art to meet the requirements of different application scenarios.

### SUMMARY

A main object of the present disclosure is to provide a visualization grouting simulation device for coal and rock fissures to solve the problems of the prior art. In the present disclosure, the diffusion law of slurry in fissures under various fissures and fissure geological conditions, as well as different slurry materials and grouting conditions can be simulated. In addition, due to the visualization of the device, the diffusion law of slurry can be visually inspected, and the actual grouting effect after grouting can be detected.

In order to solve the above technical problems, the present disclosure provides the following technical solutions. A visualization grouting device for coal and rock fissures includes a visual fissure grouting box body and a grouting device. The fissure grouting box body includes an upper top plate and a lower bottom plate, artificial protolith thin film is pasted on inner sides of the upper top plate and the lower bottom plate, a grouting hole and a plurality of pressure measuring holes are arranged in the center of the upper top plate, and the upper top plate and lower bottom plate are divided into four identical square areas, a plurality of irregular cylindrical rubber cushion blocks with different sizes being arranged on different areas, and the cushion blocks being pasted on the protolith thin film.

The grouting device includes an air compressor, a slurry storage barrel, a pneumatic stirrer, a slurry conveying pipe, a grouting pipe and an air duct; a top of the slurry storage barrel is connected to the air compressor via the air duct, and a bottom of the slurry storage barrel is arranged with a slurry control valve; the slurry control valve is connected to the grouting pipe on the fissure grouting box body via the slurry conveying pipe, the slurry control valve is further arranged with an electromagnetic flow meter for measuring a grouting amount and a grouting speed in a grouting process, and pressure gauges are arranged on the slurry storage barrel and the air compressor; the air compressor is arranged with a gas control valve connected to the slurry storage barrel via the air duct; and the pneumatic stirrer is connected to the air compressor via the air duct.

Further, the upper top plate and the lower bottom plate are made of transparent organic glass, four sides of the plates are fixed together by fastening bolts, and the artificial protolith thin film is adhered to the inner sides of the upper top plate and the lower bottom plate.

Further, peripheries of the upper top plate and the lower bottom plate are sealed by a gasket strip having certain gas permeability.

Further, a rotatably adjustable bracket is included, including a rotating shaft, an angle adjuster and stabilizing plates.

An anti-rotation pin is arranged on the angle adjuster, and the rotating shaft may be fixed after each rotation of a certain angle to simulate grouting tests under different fissure inclination angles; and the stabilizing plates are connected to the bottom plates of the fissure grouting box body to ensure the stability of the fissure grouting box body in a grouting process and serve to reinforce the bottom plates.

Further, a data acquisition system is included, including a sensor, a high-speed camera and a computer; the sensor is connected to the pressure measuring holes of the upper top plate of the fissure grouting box body; the high-speed camera is used for photographing and recording the whole process of grouting; and the computer is used for collecting and sorting analytical data.

A test method for a visualization grouting device for coal and rock fissures includes the following steps: separately pasting a layer of artificial protolith thin film on inner sides of an upper top plate and a lower bottom plate, and dividing the lower bottom plate into four square areas with the same size; one area being not processed; one area being pasted with a prism rubber pad with a triangular side surface on the bottom plate, and a corresponding size of artificial protolith thin film being pasted on a rubber pad to simulate grouting conditions of different fissure apertures; one area being pasted with a plurality of cylindrical rubber cushion blocks with the same thickness and different diameters at the bottom, and the cushion blocks being randomly distributed in the area to simulate pore channels having certain tortuosity; one area being pasted with a plurality of cylindrical rubber cushion blocks with gradually increasing thickness and different diameters from the center to the edge at the bottom, and the cushion blocks being randomly distributed in the area to simulate pore channels with different widths and certain tortuosity; and
sealing peripheries of the top and bottom plates with a gasket strip having certain gas permeability, and fixing the plates together by bolts to form a fissure visualization grouting box body;
supporting the fissure grouting box body by a rotating bracket, fixing the bottom plate of the grouting box body on stabilizing plates at a top of the bracket, and simulating grouting diffusion tests of different fissure inclination angles by adjusting a rotation angle of a rotating shaft of the bracket;
arranging the top plate of the grouting box body with a plurality of pressure measuring holes connected to a sensor, and recording pressure parameters of the grouting box body in real time by the sensor;
inserting a fixed grouting pipe into the grouting hole of the top plate of the grouting box body, and connecting the grouting pipe to a slurry control valve at a bottom of a slurry storage barrel via a slurry conveying pipe;
connecting a top of the slurry storage barrel to a gas control valve on an air compressor via an air duct;
connecting the air compressor to a pneumatic stirrer via a gas pipe;
detecting a connection state of each pipeline and the accuracy of each instrument to ensure that the test can be carried out normally, pouring a slurry material into the slurry storage barrel according to a designed proportion, opening the gas control valve on the air compressor to inject gas into the slurry storage barrel, and at the same time, opening the pneumatic stirrer in the slurry storage barrel to prevent slurry deposition, when it is observed that the reading of a pressure gauge on the slurry storage barrel reaches a specified value, the slurry control valve at the bottom of the slurry storage barrel being opened for starting grouting;
opening the sensor and a high-speed camera, recording sensor data, and observing and recording a diffusion form and range of slurry in each area in a grouting process;
observing a diffusion state of the slurry in the fissure grouting box body, stopping grouting after the slurry has expanded and filled about ¾ of the fissure grouting box body, and closing the slurry control valve and the gas control valve;
disassembling and cleaning the fissure grouting box body and grouting equipment after a pressure is eliminated; and
replacing protolith thin film with different particle sizes, sealing gasket strips with different thicknesses and gas permeability, and rubber cushion blocks with different sizes, adjusting a simulated fissure width by adjusting the bolts, repeating the above operation steps, collecting test data under different grouting conditions, and performing all grouting tests according to a design in sequence.

The advantages of the present disclosure over the prior art are that: in the present disclosure, the relationship among grouting pressure, grouting speed, grouting time, grouting amount, grouting properties, fissure widths, fissure inclination angles, fissure roughness, fissure gas permeability, tortuosity of pore channels and slurry diffusion radius is studied through simulation tests to study the diffusion law of slurry in the coal and rock mass.

In the present disclosure, a tortuous pore channel of a rock and soil medium under real conditions can be simulated by arranging irregularly distributed cushion blocks with different sizes, to reveal an actual flow process of slurry in the rock and soil medium.

In the present disclosure, by adjusting the thickness of the arranged rubber cushion blocks to change the widths of fissures, the fissure morphology of the rock mass under real conditions can be simulated.

In the present disclosure, gasket strips with different gas permeability are used for sealing the fissure grouting box body, and the fissure grouting resistance under different densities and gas permeability of media can be simulated.

In the present disclosure, the fissure box body is divided into four square areas with the same size, and different treatments are performed on the four areas, to simultaneously simulate and test the grouting diffusion effect and forms under different fissured conditions; and due to the visualization of the device, the grouting effect under real grouting conditions can be reflected, and the differences in grouting diffusion forms under different fissured conditions can be clearly and intuitively observed and compared.

### Advantages

In the present disclosure, a tortuous pore channel in the rock and soil medium under real conditions can be simulated by arranging a plurality of rubber cushion blocks in the fissure box body, these cushion blocks being used for simulating a particle skeleton inside the medium, using cylindrical rubber cushion blocks with different diameters, and randomly arranging the cushion blocks, to simulate a flow track of slurry in the rock and soil medium closer to an actual flow track.

In the prior art, “a visualization fissure grouting test device and method for simulating multiple main control variables” provides a fissure simulation grouting device, which can simulate and study the diffusion law of grouting in a fissure and the quantitative relationship between the grouting diffusion radius and multiple main control factors of grouting under static water or water-free conditions. “A dynamic water grouting test device for simulating fissures with different fillers” provides a fissure simulation grouting device, which can simulate and study the diffusion law of slurry during grouting in a filled fissure under seepage conditions.

At present, there are many experiments using a single flat plate fissure to simulate the diffusion law of slurry on a dominant fissure surface inside a fissured rock-soil body. However, the fissure network in the rock mass structure is complicated, and there is a lack of consideration on the tortuous effect of slurry flowing in a porous medium in the prior art. In the present disclosure, on the basis of considering various influencing factors of grouting in the past, cushion blocks are arranged in the fissure flat plate to simulate a tortuous channel in a porous medium, thereby further improving the rationality and accuracy of experiments.

At the same time, the grouting fissure designed in the experiment is a single fissure surface, but the complicated fissure network inside the medium determines that different media have different gas permeability under real conditions, and the previous grouting simulation device for a single flat plate fissure is only limited to the consideration of grouting influencing factors for a single fissure surface. In order to make up for the difference between the experiments and the actual situations, in the present disclosure, the gas permeability of the grouting medium is changed by changing the gas permeability of the sealing gasket strips of the fissure box body to obtain a calculation result closer to an actual grouting diffusion radius through simulation.

In addition, in the previous single flat plate fissure simulation grouting experiments, after only one grouting main control factor can be changed each time, it is necessary to re-disassemble the cleaning equipment for the next experiment. In the present disclosure, the fissure box body is divided into four square areas with the same size, different arrangements are performed in the four areas to simulate different fissure conditions, and grouting experiments under different fissure conditions are performed at the same time, which not only greatly simplifies the repeated steps of the experiments and saves a lot of experimental time, but also allows for clearer and more intuitive observation and comparison of differences in the forms of grouting diffusion under different fissure conditions due to the visualization of the experimental device.

### BRIEF DESCRIPTION OF THE DRAWINGS

FIG. 1 is an overall schematic diagram of a test device of the present disclosure.

FIG. 2 is a schematic diagram of a top plate of a fissure box body.

FIG. 3 is a schematic diagram of a bottom plate of the fissure box body.

FIG. 4 is a schematic diagram of simulated slurry diffusion lines in (c) and (d) areas.

FIG. 5 is a schematic cross-sectional view of four areas of the fissure box body taken along a midline in pairs.

Reference numerals and denotations thereof: 1—slurry storage barrel; 2—air compressor; 3—gas control valve; 4—pressure gauge; 5—air duct; 6—pneumatic stirrer; 7—slurry control valve; 8—flow meter; 9—slurry conveying pipe; 10—grouting pipe; 11—fastening bolt; 12—stabilizing plate; 13—angle adjuster; 14—rotating shaft; 15—bracket; 16—pressure measuring hole; 17—grouting hole; and 18—sealing gasket strip.

### DETAILED DESCRIPTION

Specific implementations of the present disclosure are described further below with reference to the attached drawings. The same parts are denoted by the same reference numerals.

In the description of the present disclosure, it is to be understood that the orientation or positional relationship indicated by the terms “center”, “transverse”, “upper”, “lower”, “left”, “right”, “vertical”, “horizontal”, “top”, “bottom”, “inner” and “outer” is based on that shown in the attached drawings and merely for the ease of describing the present disclosure and simplifying the description, rather than indicating or implying that the device or element referred to must be in a specific orientation, and constructed and operated in a specific orientation. Therefore, it is not to be understood as a limitation of the present disclosure. Furthermore, the terms “first” and “second” are used for descriptive purposes only and are not to be construed as indicating or implying relative importance or implicitly indicating the number of technical features indicated. Therefore, a feature defined as “first” or “second” may explicitly or implicitly include one or more of the feature. In the description of the present disclosure, unless otherwise indicated, “a plurality of” means two or more. In addition, the terms “include” and any variations thereof, are intended to cover a non-exclusive inclusion.

### Embodiments

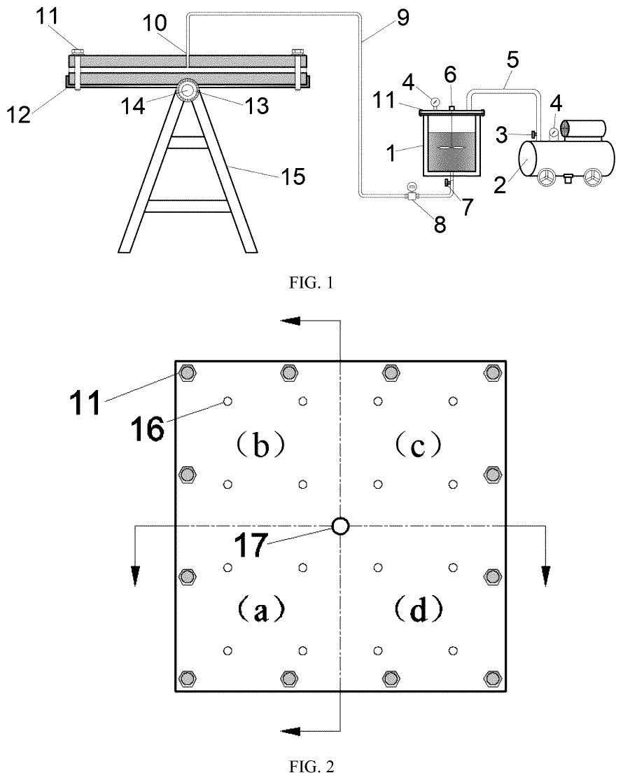

As shown in FIG. 1, an overall schematic diagram of a test device of the present disclosure is shown, including a fissure grouting box body, a rotating bracket 15 and a grouting device.

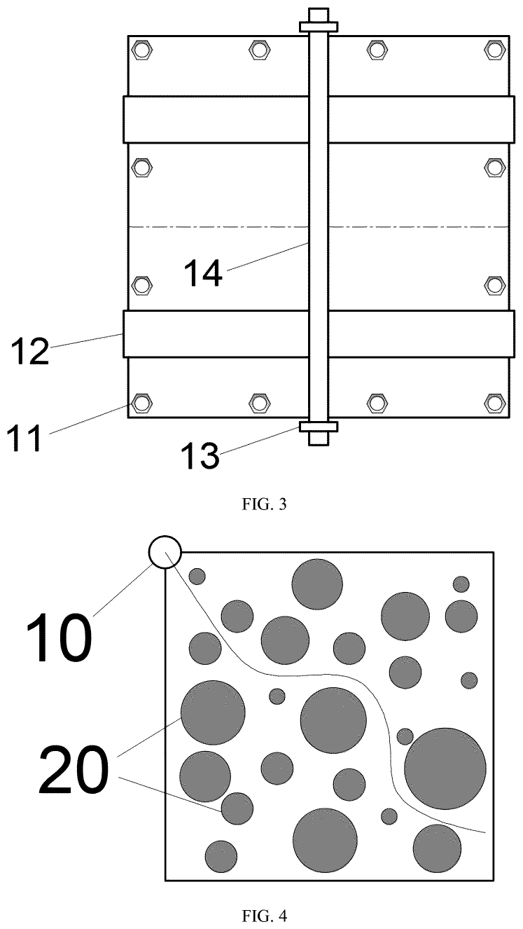

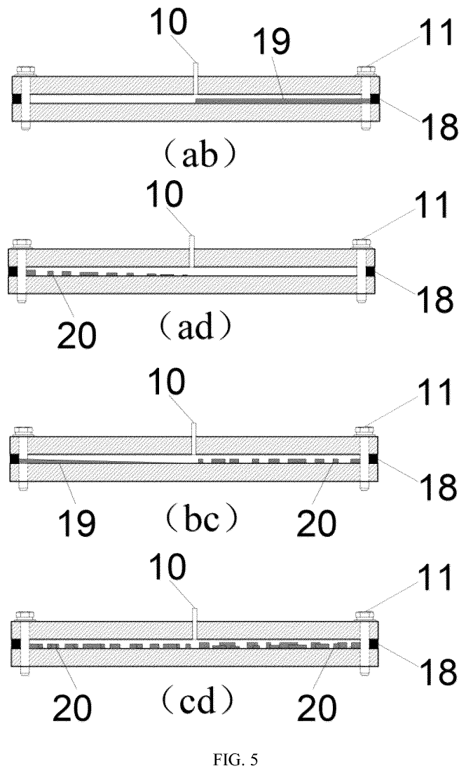

As shown in FIGS. 2 and 3, the fissure grouting box body includes an upper top plate, a lower bottom plate, a sealing gasket strip 18 and fastening bolts 11. The top and bottom plates are made of transparent organic glass with a size of (1000×1000×20 mm). Artificial protolith thin film with a size of (980×980×0.1 mm) was pasted on inner sides of the upper top plate and the lower bottom plate, and a grouting hole 17 and a plurality of pressure measuring holes 16 were arranged in the center of the upper top plate. The lower bottom plate was divided into four square areas with the same size; one area being not processed; one area being pasted with a prism rubber pad with a triangular side surface on the bottom plate, and a corresponding size of artificial protolith thin film being pasted on a rubber pad to simulate grouting conditions of different fissure apertures; one area being pasted with a plurality of cylindrical rubber cushion blocks with the same thickness and different diameters at the bottom, and the cushion blocks being randomly distributed in the area to simulate pore channels having a certain tortuosity; and one area being pasted with a plurality of cylindrical rubber cushion blocks with gradually increasing thickness and different diameters from the center to the edge at the bottom, and the cushion blocks being randomly distributed in the area to simulate pore channels with different widths and a certain tortuosity.

In the experiment, according to different test requirements, sealing gasket strips 18 with different gas permeability, artificial protolith thin film with different sizes and protolith particle sizes, rubber pads with different sizes, and rubber cushion blocks with different sizes were replaced, and the spacing of fastening bolts 11 was adjusted to simulate grouting processes under the conditions of different fissure widths, fissure roughness and grouting resistance.

As shown in FIGS. 1 and 3, the rotating bracket 15 includes a rotating shaft 14, an angle adjuster 13, and stabilizing plates 12. An anti-rotation pin was arranged on the angle adjuster 13, and the rotating shaft 14 could be fixed after each rotation of a certain angle to simulate the grouting process under different fissure inclination angles. The stabilizing plates 12 were welded on the rotating shaft 14 to be connected to the lower bottom plate of the fissure grouting box body to ensure the stability of the fissure grouting box body in a grouting process and serve to reinforce the lower bottom plate.

As shown in FIGS. 2 and 4, the fissure box body was divided into four small square areas (a), (b), (c) and (d) with the same size. The area (a) was pasted with the protolith thin film with a corresponding size on the bottom plate. The area (b) was pasted with a prism rubber pad with a triangular side surface on the bottom plate, and the artificial protolith thin film with a corresponding size was pasted on the rubber pad, to simulate grouting conditions with different fissure apertures. The area (c) was pasted with a corresponding size of protolith thin film at the bottom, a plurality of cylindrical rubber cushion blocks with the same thickness and different diameters were pasted on the protolith thin film, and the cushion blocks were randomly distributed in the area to simulate pore channels with certain tortuosity. The area (d) was pasted with a corresponding size of protolith thin film at the bottom, a plurality of cylindrical rubber cushion blocks were pasted with gradually increasing thickness and different diameters from the center to the edge on the protolith thin film, and the cushion blocks were randomly distributed in the area to simulate pore channels with different widths and certain tortuosity. The periphery of the top and bottom plates was sealed with a gasket strip having certain gas permeability and fixed together with fastening bolts 11 to form the fissure grouting box body for simultaneously simulating different fissure conditions.

As shown in FIG. 1, the grouting device includes an air compressor 2, a slurry storage barrel 1, a pneumatic stirrer 6, a slurry conveying pipe 9, a grouting pipe 10 and an air duct 5. A top of the slurry storage barrel 1 was connected to the air compressor 2 via the air duct 5, and a bottom of the slurry storage barrel 1 was arranged with a slurry control valve 7; the slurry control valve 7 was connected to the grouting pipe 10 on the fissure grouting box body via the slurry conveying pipe 9, the slurry control valve 7 was further arranged with an electromagnetic flow meter 8 for measuring a grouting amount and a grouting speed in a grouting process, and pressure gauges 4 were arranged on the slurry storage barrel 1 and the air compressor 2; the air compressor 2 was arranged with a gas control valve 3 connected to the slurry storage barrel 1 via the air duct 5; and the pneumatic stirrer 6 was connected to the air compressor 2 via the air duct 5.

The specific implementation steps were as follows:

### 1) Assembly of Experimental Devices

(1) Manufacture of rubber cushion blocks: a rubber pad with a good bearing capacity and low deformation tendency was selected, and machined into a prism with a right-angled triangle side surface by a machine, and a plurality of rubber pads with different sizes were machined, with the thickness being controlled between 0.1-0.5 mm. Likewise, the rubber pads were machined into cylinders with different thicknesses and diameters, and a plurality of rubber cushion blocks with different sizes were machined, with the thickness being controlled between 0.1-0.7 mm.

(2) Preparation of protolith thin film: protolith samples were ground into protolith particles with different particle sizes through a rock grinding machine, and different grades were selected through test screening. A layer of glue was coated on a transparent thin film, and the sorted protolith particles (selected according to roughness) were uniformly smeared on the thin film. After drying, the artificial protolith pasting film was cut into corresponding sizes according to a divided area size of a glass plate and different specifications of the rubber pad, and the artificial protolith pasting film was pasted on the upper top plate, the lower bottom plate and the rubber pad to make artificial protolith fissures with different roughness and different widths.

(3) Manufacture of sealing gasket strips 18: a sealing material with certain gas permeability was selected, making into strips with a size of 980 mm in length, 20 mm in width and 0.1-1 mm in thickness, and the strips were pasted around the fissure grouting box body.

(4) An angle of the rotating shaft 14 was adjusted according to an experimental design, and the fissure box body was fixed on the stabilizing plates 12 of the rotating shaft 14.

(5) Connection of pipelines: a sensor was connected to pressure measuring holes 16 of the upper top plate of the fissure box body via a data line; a slurry control valve 7 at a bottom of a slurry storage barrel 1 was connected to a grouting pipe 10 at a top of the fissure grouting box body via a slurry conveying pipe 9, the slurry storage barrel I was connected to an air compressor 2 via an air duct 5, and the air compressor 2 was connected to a pneumatic stirrer 6 via the air duct 5.

### 2) Performing of Grouting Experiments

(1) The tightness of device and various pipelines was detected, and it was detected whether each instrument switch could work normally to ensure that the equipment could perform the experiment normally.

(2) A slurry material was prepared according to matching requirements and poured into the slurry storage barrel 1, the gas control valve 3 on the air compressor 2 was opened to inject gas into the slurry storage barrel 1, and the pneumatic stirrer 6 in the slurry storage barrel 1 was opened at the same time to prevent slurry deposition. When it was observed that the reading of the pressure gauge 4 on the slurry storage barrel 1 reached a specified value, the slurry control valve 7 at the bottom of the slurry storage barrel 1 was opened for starting grouting.

(3) In a grouting process, the sensor and the high-speed camera were opened, and the diffusion form and scope of slurry in each area were observed and recorded in real time.

(4) Grouting was stopped and the valve was closed before the slurry fills the fissure box body completely. After the pressure was removed, the fissure box body was disassembled, and the box body and grouting equipment were cleaned.

### 3) Repetition of Experiments

According to the experimental scheme, the grouting resistance was changed by replacing the sealing gasket strips 18 with different sizes and gas permeability. The rubber pads and artificial protolith thin film with different specifications and sizes were replaced, the fastening bolts 11 were adjusted to adjust the fissure widths to change the grouting conditions, and the above operations were repeated under different grouting conditions to carry out grouting diffusion experiments under different grouting conditions.

### 4) Analysis of Experimental Data

After all grouting experiments were finished, the experimental data were sorted out, the monitoring data and images were statistically analyzed, and the law of slurry migration and diffusion was analyzed.

The present disclosure and implementations thereof have been described above, and this description is not limited. What is shown in the specific implementations is only some, rather than all embodiments of the present disclosure, and an actual structure is not limited to this. In a word, if the ordinary technicians in this field are inspired, it is to be within the scope of protection of the present disclosure to design a structural mode and an embodiment similar to the technical solution without deviating from the creative purpose of the present disclosure.

1. A visualization grouting device for coal and rock fissures, comprising a visual fissure grouting box body and a grouting device, wherein the fissure grouting box body comprises an upper top plate and a lower bottom plate, artificial protolith thin film is pasted on inner sides of the upper top plate and the lower bottom plate, a grouting hole (17) and a plurality of pressure measuring holes (16) are arranged in the center of the upper top plate, and the upper top plate and lower bottom plate are divided into four identical square areas, a plurality of irregular cylindrical rubber cushion blocks with different sizes being arranged on different areas, and the cushion blocks being pasted on the protolith thin film; and
the grouting device comprises an air compressor (2), a slurry storage barrel (1), a pneumatic stirrer (6), a slurry conveying pipe (9), a grouting pipe (10) and an air duct (5); a top of the slurry storage barrel (1) is connected to the air compressor (2) via the air duct (5), and a bottom of the slurry storage barrel (1) is arranged with a slurry control valve (7); the slurry control valve (7) is connected to the grouting pipe (10) on the fissure grouting box body via the slurry conveying pipe (9), the slurry control valve (7) is further arranged with an electromagnetic flow meter (8) for measuring a grouting amount and a grouting speed in a grouting process, and pressure gauges (4) are arranged on the slurry storage barrel (1) and the air compressor (2); the air compressor (2) is arranged with a gas control valve (3) connected to the slurry storage barrel (1) via the air duct (5); and the pneumatic stirrer (6) is connected to the air compressor (2) via the air duct (5).

2. The visualization grouting device for coal and rock fissures according to claim 1, wherein the upper top plate and the lower bottom plate are made of transparent organic glass, four sides of the plates are fixed together by fastening bolts (11), and the artificial protolith thin film is adhered to the inner sides of the upper top plate and the lower bottom plate.

3. The visualization grouting device for coal and rock fissures according to claim 2, wherein peripheries of the upper top plate and the lower bottom plate are sealed by a gasket strip having certain gas permeability.

4. The visualization grouting device for coal and rock fissures according to claim 1, further comprising a rotatably adjustable bracket (15) comprising a rotating shaft (14), an angle adjuster (13) and stabilizing plates (12), wherein
an anti-rotation pin is arranged on the angle adjuster (13), and the rotating shaft (14) may be fixed after each rotation of a certain angle to simulate grouting tests under different fissure inclination angles; and the stabilizing plates (12) are connected to the bottom plate of the fissure grouting box body to ensure the stability of the fissure grouting box body in a grouting process and serve to reinforce the bottom plate.

5. The visualization grouting device for coal and rock fissures according to claim 1, further comprising a data acquisition system comprising a sensor, a high-speed camera and a computer; the sensor is connected to the pressure measuring holes (16) of the upper top plate of the fissure grouting box body; the high-speed camera is used for photographing and recording the whole process of grouting; and the computer is used for collecting and sorting analytical data.

6. A test method for a visualization grouting device for coal and rock fissures, comprising the following steps:
1) separately pasting a layer of artificial protolith thin film on the inner sides of an upper top plate and a lower bottom plate, and dividing the lower bottom plate into four square areas with the same size;
one area being not processed;
one area being pasted with a prism rubber pad with a triangular side surface on the bottom plate, and a corresponding size of artificial protolith thin film being pasted on the rubber pad to simulate grouting conditions of different fissure apertures;
one area being pasted with a plurality of cylindrical rubber cushion blocks with the same thickness and different diameters at the bottom, and the cushion blocks being randomly distributed in the area to simulate pore channels having certain tortuosity; and
one area being pasted with a plurality of cylindrical rubber cushion blocks with gradually increasing thickness and different diameters from the center to the edge at the bottom, and the cushion blocks being randomly distributed in the area to simulate pore channels with different widths and certain tortuosity; and
sealing peripheries of the top and bottom plates with a gasket strip having certain gas permeability, and fixing the plates together by bolts to form a fissure visualization grouting box body;
2) supporting the fissure grouting box body by a rotating bracket (15), fixing the bottom plate of the grouting box body on stabilizing plates (12) at a top of the bracket (15), and simulating grouting diffusion tests of different fissure inclination angles by adjusting a rotation angle of a rotating shaft of the bracket (15);
3) arranging the top plate of the grouting box body with a plurality of pressure measuring holes (16) connected to a sensor, and recording pressure parameters of the grouting box body in real time by the sensor; and
4) opening the sensor and a high-speed camera, recording sensor data, and observing and recording a diffusion form and range of slurry in each area in a grouting process;
observing a diffusion state of the slurry in the fissure grouting box body, stopping grouting after the slurry has expanded and filled about ¾ of the fissure grouting box body, and closing a slurry control valve (7) and a gas control valve (3);
disassembling and cleaning the fissure grouting box body and grouting equipment after a pressure is eliminated; and
replacing protolith thin film with different particle sizes, sealing gasket strips (18) with different thicknesses and gas permeability, and rubber cushion blocks with different sizes, adjusting a simulated fissure width by adjusting the bolts, repeating the above operation steps, collecting test data under different grouting conditions, and performing all grouting tests according to a design in sequence.
